(19) United States
(12) Patent Application Publication
(10) Pub. No.: US 2026/0023287 A1
(43) Pub. Date: Jan. 22, 2026

(54) ELECTRO-OPTICAL DEVICE, AND ELECTRONIC APPARATUS

(71) Applicant: SEIKO EPSON CORPORATION, Tokyo (JP)

(72) Inventor: Noboru KOYAMA, SHIOJIRI-SHI (JP)

(73) Assignee: SEIKO EPSON CORPORATION, Tokyo (JP)

(21) Appl. No.: 19/276,002

(22) Filed: Jul. 22, 2025

(30) Foreign Application Priority Data
Jul. 22, 2024 (JP) 2024-116776

(51) Int. Cl. G02F 1/1343

(52) U.S. Cl. CPC G02F 1/134309

(57) ABSTRACT

An electro-optical device includes an electro-optical layer, a first electrode disposed outside a pixel region, a second electrode disposed outside the pixel region and applied with a potential different from that of the first electrode, and a concave-convex member disposed between the first electrode and the second electrode in plan view.

The present application is based on, and claims priority from JP Application Serial Number 2024-116776, filed Jul. 22, 2024, the disclosure of which is hereby incorporated by reference herein in its entirety.

### BACKGROUND

### 1. Technical Field

The present disclosure relates to an electro-optical device and electronic apparatus.

### 2. Related Art

An electro-optical device having a liquid crystal material as an electro-optical substance is known. An electro-optical device disclosed in JP 2012-252032 A includes a pair of substrates, a seal material for bonding the pair of substrates to each other, and an electro-optical substance. At least one substrate of the pair of substrates includes a concave ion adsorption portion at a surface in contact with the electro-optical substance. The ion adsorption portion adsorbs ionic impurities in the electro-optical substance. The ion adsorption portion suppresses deterioration in display quality due to the ionic impurities.

In the configuration using the concave ion adsorption portion, the suppression of the deterioration in display quality due to the ionic impurities may be insufficient.

### SUMMARY

An electro-optical device of the present disclosure includes an electro-optical layer, a first electrode disposed outside a pixel region, a second electrode disposed outside the pixel region and applied with a potential different from that of the first electrode, and a concave-convex member disposed between the first electrode and the second electrode in plan view.

An electro-optical device of the present disclosure includes an electro-optical layer, a first electrode disposed outside a pixel region, a second electrode disposed outside the pixel region and applied with a potential different from that of the first electrode, and a concave-convex member covering at least one of the first electrode and the second electrode.

An electronic apparatus of the present disclosure includes the above-described electro-optical device.

### BRIEF DESCRIPTION OF THE DRAWINGS

FIG. 1 is a diagram illustrating a schematic configuration of a liquid crystal device.

FIG. 2 is a diagram schematically illustrating a configuration of the liquid crystal device.

FIG. 3 is a diagram illustrating an electrical configuration of an element substrate.

FIG. 4 is a diagram illustrating a schematic configuration of the liquid crystal device.

FIG. 5 is a diagram illustrating an example of a schematic configuration of a liquid crystal device.

FIG. 6 is a diagram illustrating an example of a schematic configuration of the liquid crystal device.

FIG. 7 is a diagram illustrating an example of a schematic configuration of the liquid crystal device.

FIG. 8 is a diagram illustrating an example of a schematic configuration of a liquid crystal device.

FIG. 9 is a diagram illustrating an example of a schematic configuration of a liquid crystal device.

FIG. 10 is a diagram illustrating a manufacturing process of the element substrate of the liquid crystal device.

FIG. 11 is a diagram illustrating a manufacturing process of the element substrate of the liquid crystal device.

FIG. 12 is a diagram illustrating a manufacturing process of the element substrate of the liquid crystal device.

FIG. 13 is a diagram illustrating a manufacturing process of the element substrate of the liquid crystal device.

FIG. 14 is a diagram illustrating a manufacturing process of the element substrate of the liquid crystal device.

FIG. 15 is a diagram illustrating a manufacturing process of the element substrate of the liquid crystal device.

FIG. 16 is a diagram illustrating a manufacturing process of the element substrate of the liquid crystal device.

FIG. 17 is a diagram illustrating a manufacturing process of the element substrate of the liquid crystal device.

FIG. 18 is a diagram illustrating an example of a schematic configuration of a liquid crystal device.

FIG. 19 is a diagram illustrating an example of a schematic configuration of a liquid crystal device.

FIG. 20 is a diagram illustrating a schematic configuration of a projection-type display device.

### DESCRIPTION OF EMBODIMENTS

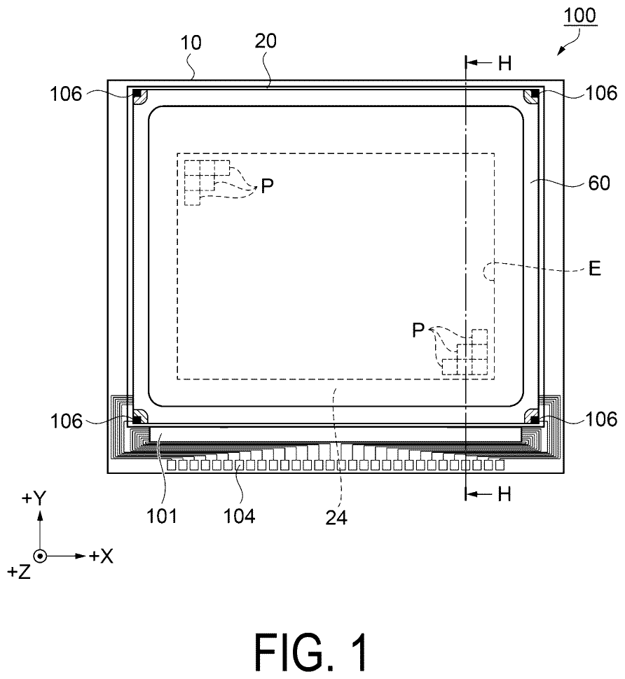

FIG. 1 illustrates a schematic configuration of a liquid crystal device 100. The liquid crystal device 100 corresponds to an example of an electro-optical device. The liquid crystal device 100 includes, as an example, an active matrix driving type thin film transistor (TFT) liquid crystal. FIG. 1 illustrates the liquid crystal device 100 in plan view from a +Z direction. The liquid crystal device 100 includes an element substrate 10, a counter substrate 20, a liquid crystal layer 50 described later, and a seal material 60. The liquid crystal device 100 includes a display region E.

In a plurality of drawings including FIG. 1, dimensions of each component may be illustrated differently from actual dimensions in order to facilitate understanding of each component. Dimensional ratios of the respective components in the drawings are different from actual dimensional ratios of the respective components.

The plurality of drawings including FIG. 1 each illustrate an XYZ coordinate system. An X-axis, a Y-axis, and a Z-axis are axes orthogonal to one another. The Z-axis is an axis parallel to a direction in which the element substrate 10, the liquid crystal layer 50, and the counter substrate 20 are stacked. The +Z direction is a direction oriented from the element substrate 10 toward the counter substrate 20. A −Z direction is a direction oriented from the counter substrate 20 toward the element substrate 10. The X-axis is an axis parallel to a direction in which external coupling terminals 104 described later are arrayed. A +X direction is a direction oriented from left to right in FIG. 1. A −X direction is a direction oriented from right to left in FIG. 1. The Y-axis is an axis orthogonal to the X-axis and the Z-axis. A +Y direction is a direction oriented from bottom to top in FIG. 1. A −Y direction is a direction oriented from top to bottom in FIG. 1.

The element substrate 10 is disposed on a light emission side of the liquid crystal layer 50. The element substrate 10 is formed of a member having a transmissive property. The transmissive property means having a property of transmitting visible light. The transmissive property may indicate that a transmittance of visible light is 50% or more. The element substrate 10 is formed in a substantially rectangular shape in plan view from the +Z direction. The element substrate 10 is bonded to the counter substrate 20 via a seal material 60. The element substrate 10 is formed to be larger than the counter substrate 20 in plan view from the +Z direction. The element substrate 10 includes a data line drive circuit 101, a scanning line drive circuit, an inspection circuit, and a plurality of the external coupling terminals 104. The scanning line drive circuit and the inspection circuit are not illustrated.

The data line drive circuit 101 is electrically coupled to a plurality of data lines 6 described later. The data line drive circuit 101 supplies an image signal to each of the plurality of data lines 6. The data line drive circuit 101 is provided between the plurality of external coupling terminals 104 and the seal material 60 in plan view from the +Z direction.

The scanning line drive circuit is electrically coupled to a plurality of scanning lines 3 described later. The scanning line drive circuit supplies a scanning signal to each of the plurality of scanning lines 3.

The inspection circuit is electrically coupled to the plurality of data lines 6. The inspection circuit supplies an inspection signal to each of the plurality of data lines 6.

The external coupling terminal 104 is a mounting terminal at which an external coupling line such as a flexible printed circuit (FPC) (not illustrated) is mounted. Various signals including an image signal, a synchronization signal, an inspection signal, a common potential, a power supply potential, and the like are supplied to the external coupling terminals 104 from outside via the external coupling lines. The external coupling terminal 104 is provided in a region of the element substrate 10 that does not overlap the counter substrate 20.

The counter substrate 20 is disposed on a light incident side of the liquid crystal layer 50. The counter substrate 20 is formed in a substantially rectangular shape in plan view from the +Z direction. The counter substrate 20 is formed of a member having a transmissive property. The counter substrate 20 is bonded to the element substrate 10 via the seal material 60. The counter substrate 20 is provided with a plurality of vertical conduction portions 106.

The plurality of vertical conduction portions 106 are provided at corners of the counter substrate 20, respectively. The liquid crystal device 100 illustrated in FIG. 1 includes four vertical conduction portions 106. The vertical conduction portion 106 electrically couples a common electrode 21 described later and any of the plurality of external coupling terminals 104 to each other.

The seal material 60 bonds the element substrate 10 and the counter substrate 20 to each other. The seal material 60 is disposed along an outer edge of the counter substrate 20. The seal material 60 is formed of a resin material having a curing property such as a thermosetting property or an ultraviolet curing property. The resin material contains ionic impurities Im derived from raw materials such as a curing agent. The ionic impurities Im may be eluted into the liquid crystal layer 50. The seal material 60 may include a gap material made of an inorganic material such as glass.

The display region E is provided in a region inside the seal material 60. The display region E is a pixel region including a plurality of pixels P. The plurality of pixels P are disposed in a matrix along the X-axis and the Y-axis. A dummy pixel that does not contribute to display may be disposed at an outer peripheral edge of the cover region E or on an outside of the display region E.

A partition portion 24 is provided between the seal material 60 and the display region E. The partition portion 24 surrounds the outside of the display region E. The partition portion 24 is formed in a substantially rectangular shape having sides along the X-axis and the Y-axis. The scanning line drive circuit and the inspection circuit are disposed at positions overlapping the partition portion 24 in plan view from the +Z direction.

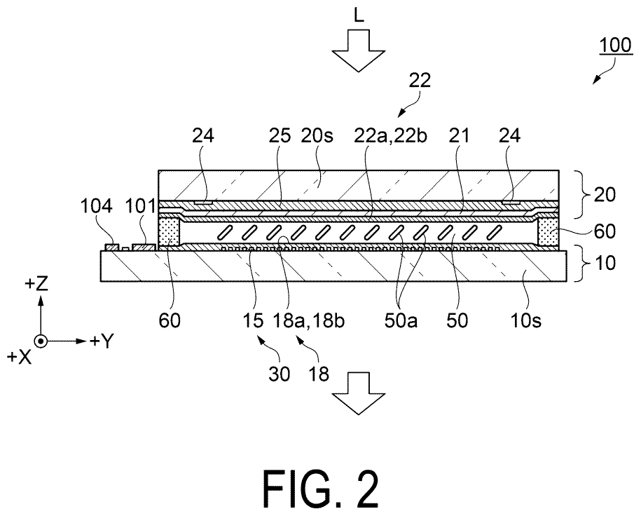

FIG. 2 schematically illustrates a configuration of the liquid crystal device 100. FIG. 2 illustrates a cross-section that includes a line segment H-H in FIG. 1 and is along a Y-Z plane. FIG. 2 illustrates sizes and the number of liquid crystals 50a included in the liquid crystal layer 50 in a different manner from an actual manner.

The liquid crystal device 100 illustrated in FIG. 2 is a transmissive-type liquid crystal device. Incident light L is incident from a surface of the counter substrate 20 in the +Z direction. The incident light L is transmitted through the liquid crystal layer 50 and is emitted from a surface of the element substrate 10 in the −Z direction. The incident light L is modulated according to an alignment state of the liquid crystals 50a while being transmitted through the liquid crystal layer 50. An incident surface of the incident light L is not limited to the surface of the counter substrate 20 in the +Z direction. The incident surface of the incident light L may be the surface of the element substrate 10 in the −Z direction. The liquid crystal device 100 is not limited to the transmissive-type liquid crystal device. The liquid crystal device 100 may be a reflection-type liquid crystal device. Optical design for a normally white mode or normally black mode is used for the liquid crystal device 100. The liquid crystal device 100 may include a polarizing element.

The element substrate 10 and the counter substrate 20 are disposed facing each other via the seal material 60. The liquid crystal layer 50 is disposed between the element substrate 10 and the counter substrate 20. The liquid crystal layer 50 is disposed at a position surrounded by the element substrate 10, the counter substrate 20, and the seal material 60.

The liquid crystal layer 50 includes the display region E. The liquid crystal layer 50 corresponds to an example of an electro-optical layer. The liquid crystal layer 50 includes the liquid crystals 50a. The liquid crystals 50a have positive or negative dielectric anisotropy. The liquid crystals 50a illustrated in FIG. 2 have negative dielectric anisotropy as an example. The liquid crystals 50a denote individual liquid crystal molecules or an aggregate of individual liquid crystal molecules.

The element substrate 10 includes an element substrate base 10s, a wiring layer (not illustrated), a pixel electrode 15, and a first alignment film 18. The element substrate base 10s, the wiring layer, the pixel electrode 15, and the first alignment film 18 are disposed in an order of the element substrate base 10s, the wiring layer, the pixel electrode 15, and the first alignment film 18 toward the liquid crystal layer 50.

The element substrate base 10s is a flat plate having transmissive and insulation properties. The element substrate base 10s is formed of a glass substrate or a quartz substrate. The element substrate base 10s is disposed on an emission side with respect to the liquid crystal layer 50, on which light passing through the liquid crystal layer 50 is emitted.

The wiring layer includes a transistor 30, the scanning line 3, the data line 6, and the like, which will be described later. The wiring layer includes a plurality of layers. The wiring layer has a function of shielding the transistor 30 from light.

The pixel electrode 15 is provided in the display region E. The pixel electrode 15 has a transmissive property. The pixel electrode 15 is made of indium tin oxide (ITO), as an example. The pixel electrode 15 may be made of a transparent conductive material such as indium zinc oxide (IZO) and fluorine-doped tin oxide (FTO).

The first alignment film 18 aligns the liquid crystals 50a. The first alignment film 18 is formed based on the optical design of the liquid crystal device 100. The first alignment film 18 is disposed at a position in contact with the seal material 60. The first alignment film 18 has a region in contact with a surface of the seal material 60 in the −Z direction and a region facing the liquid crystal layer 50. The first alignment film 18 is disposed to cover a plurality of the pixel electrodes 15 and the liquid crystal layer 50. The first alignment film 18 includes a first vapor deposition film 18a and a second vapor deposition film 18b.

The first vapor deposition film 18a is formed by vacuum vapor deposition from an upper side of a surface in the +Z direction of the element substrate 10. The first vapor deposition film 18a includes a plurality of columns in which long axes are along the Z-axis. The first vapor deposition film 18a is made of silicon oxide, aluminum oxide, magnesium oxide, or the like.

The second vapor deposition film 18b is formed above the first vapor deposition film 18a. A thickness of the second vapor deposition film 18b along the Z-axis is smaller than a thickness of the first vapor deposition film 18a along the Z-axis. The second vapor deposition film 18b includes a plurality of columns in which long axes intersect the Z-axis at a predetermined angle. The columns of the second vapor deposition film 18b are columnar crystals of silicon oxide. The columns of the second vapor deposition film 18b are formed by oblique vapor deposition by a vacuum vapor deposition method.

The counter substrate 20 includes a counter substrate base 20s, the partition portion 24, an insulating layer 25, the common electrode 21, and a second alignment film 22. The counter substrate base 20s, the partition portion 24, the insulating layer 25, the common electrode 21, and the second alignment film 22 are disposed in an order of the counter substrate base 20s, the partition portion 24, the insulating layer 25, the common electrode 21, and the second alignment film 22 toward the liquid crystal layer 50.

The counter substrate base 20s is a flat plate having transmissive and insulation properties. The counter substrate base 20s is disposed on the incident side on which the incident light L is incident. The counter substrate base 20s is formed of a glass substrate or a quartz substrate. The counter substrate base 20s is made of, as an example, silicon oxide (SiO₂) having a refractive index of 1.48.

The partition portion 24 is formed of a metal film or the like having a light shielding property. The partition portion 24 is disposed at a position farther in the +Z direction than the common electrode 21.

The insulating layer 25 has transmissive and insulation properties. The insulating layer 25 is formed of an inorganic material such as silicon oxide. The insulating layer 25 may function as a light path adjustment layer that adjusts an optical path of the incident light L.

The common electrode 21 is disposed facing the plurality of pixel electrodes 15. The common electrode 21 is formed of ITO. The common electrode 21 may be formed of a transparent conductive material such as IZO or ITO. The common electrode 21 and the pixel electrode 15 apply an electric field to the liquid crystal layer 50. The common electrode 21 is electrically coupled to any of the plurality of external coupling terminals 104 provided at the element substrate 10 via the vertical conduction portions 106. A common electrode potential is applied to the common electrode 21 via the external coupling terminal 104. The common electrode potential is, as an example, 6.5 V.

The second alignment film 22 aligns the liquid crystals 50a. The second alignment film 22 is formed based on the optical design of the liquid crystal device 100. The second alignment film 22 is disposed at a position in contact with the seal material 60. The second alignment film 22 has a region in contact with a surface of the seal material 60 in the +Z direction and a region facing the liquid crystal layer 50. The second alignment film 22 is disposed between the common electrode 21 and the liquid crystal layer 50. The second alignment film 22 includes a third vapor deposition film 22a and a fourth vapor deposition film 22b.

The third vapor deposition film 22a is formed by applying vacuum vapor deposition to a surface of the counter substrate 20 in the −Z direction. The third vapor deposition film 22a includes a plurality of columns in which long axes are along the Z-axis. The third vapor deposition film 22a is made of silicon oxide, aluminum oxide, magnesium oxide, or the like.

The fourth vapor deposition film 22b is formed above the third vapor deposition film 22a. A thickness of the fourth vapor deposition film 22b along the Z-axis is smaller than a thickness of the third vapor deposition film 22a along the Z-axis. The fourth vapor deposition film 22b includes a plurality of columns in which long axes intersect the Z-axis at a predetermined angle. The columns of the fourth vapor deposition film 22b are columnar crystals of silicon oxide. The columns of the fourth vapor deposition film 22b are formed by oblique vapor deposition by a vacuum vapor deposition method.

The first alignment film 18 and the second alignment film 22 align the liquid crystals 50a having negative dielectric anisotropy substantially vertically. The substantially vertical alignment indicates an alignment state of inversely standing while a pre-tilt angle of less than 90° is given. The first alignment film 18 and the second alignment film 22 give a pre-tilt to and vertically align the liquid crystals 50a. An inclination direction of the pre-tilt is along a direction intersecting the X-axis and the Y-axis. When the liquid crystal layer 50 is driven, the alignment state of the liquid crystals 50a, which is given the pre-tilt and vertically aligned, changes in the inclination direction.

Each of the first alignment film 18 and the second alignment film 22 illustrated in FIG. 2 includes two layers, but is not limited thereto. Each of the first alignment film 18 and the second alignment film 22 may include three or more layers.

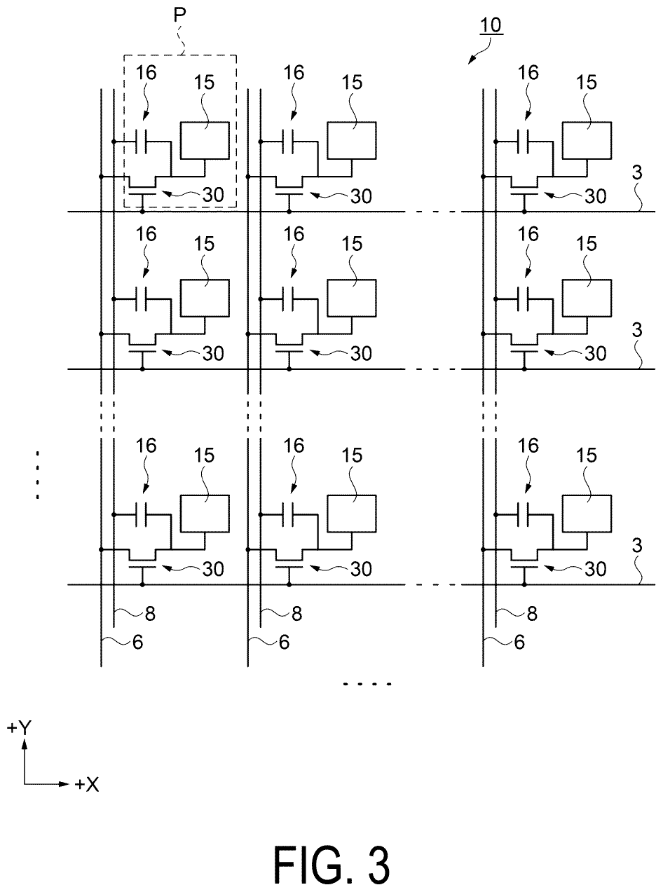

FIG. 3 illustrates an electrical configuration of the element substrate 10. FIG. 3 illustrates the electrical configuration of the element substrate 10 in an equivalent circuit diagram. A plurality of the scanning lines 3, a plurality of the data lines 6, a plurality of capacitance lines 8, a plurality of the pixel electrodes 15, a plurality of capacitance elements 16, and a plurality of the transistors 30 are provided in the display region E of the element substrate 10. The plurality of scanning lines 3, the plurality of data lines 6, and the plurality of capacitance lines 8 are insulated from each other. The pixel electrode 15, the capacitance element 16, and the transistor 30 are provided in a region of the pixel P divided by the scanning lines 3 and the data lines 6. The pixel electrode 15, the capacitance element 16, and the transistor 30 constitute a pixel circuit of the pixel P.

The scanning line 3 is electrically coupled to a gate of the transistor 30. The scanning line 3 illustrated in FIG. 3 extends along the X-axis. The scanning line 3 simultaneously controls on/off of the transistors 30 provided in the same row. The scanning line 3 is electrically coupled to the scanning line drive circuit. The scanning line 3 supplies the pixel P with a scanning signal supplied from the scanning line drive circuit. The scanning signal is supplied to the scanning line 3 at a predetermined timing.

The data line 6 is electrically coupled to a source/drain region on the data line side of the transistor 30. The data line 6 illustrated in FIG. 3 extends along the Y-axis. The data line 6 is electrically coupled to the data line drive circuit 101. The data line 6 supplies the pixel P with an image signal supplied from the data line drive circuit 101.

The capacitance line 8 is electrically coupled to the capacitance element 16. The capacitance line 8 illustrated in FIG. 3 extends along the Y-axis. The capacitance line 8 may extend along the X-axis. A constant potential such as a common electrode potential or a ground potential applied to the common electrode 21 is applied to the capacitance line 8 via the external coupling terminal 104.

The pixel electrode 15 is electrically coupled to a source/drain region on the capacitance line side of the transistor 30. When the transistor 30 is brought into an on-state for a certain period of time by input of a scanning signal, an image signal is applied to the pixel electrode 15 at a predetermined timing. The image signal is written at a predetermined level to the liquid crystal layer 50 via the pixel electrode 15. The image signal is held for a certain period of time between the pixel electrode 15 and the common electrode 21 with the liquid crystal layer 50 interposed therebetween. The alignment state of the liquid crystals 50a changes depending on a voltage applied in accordance with the image signal.

The capacitance element 16 includes two electrodes. One electrode of the capacitance element 16 is electrically coupled to the capacitance line 8. Another electrode of the capacitance element 16 is electrically coupled to the pixel electrode 15. The other electrode of the capacitance element 16 holds a potential of the image signal or the like supplied to the pixel electrode 15. The capacitance element 16 prevents leakage of the image signal held in the pixel electrode 15.

The transistor 30 is a switching element provided for the pixel electrode 15. The transistor 30 is, as an example, a thin film transistor (TFT). The transistor 30 is provided corresponding to each of intersections between the plurality of scanning lines 3 and the plurality of data lines 6.

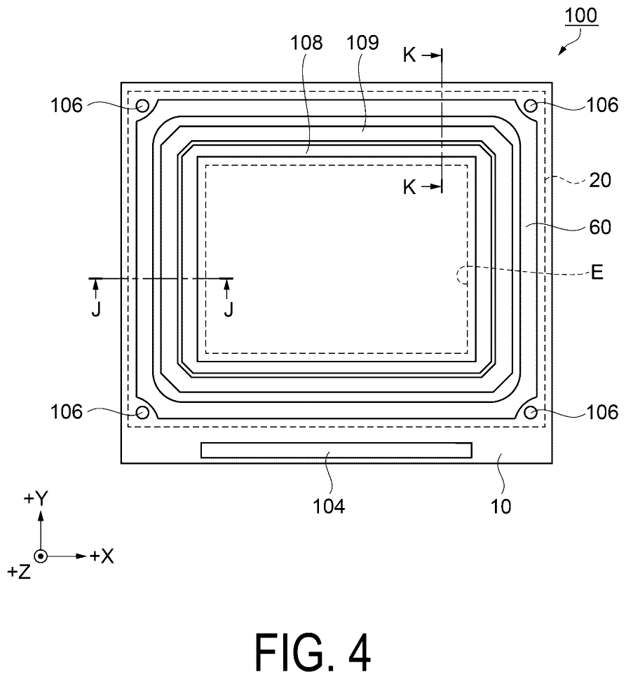

FIG. 4 illustrates a schematic configuration of the liquid crystal device 100. FIG. 4 illustrates the liquid crystal device 100 in plan view from the +Z direction. FIG. 4 illustrates a first peripheral electrode 108 and a second peripheral electrode 109.

The first peripheral electrode 108 attracts the ionic impurities Im. The first peripheral electrode 108 is disposed at position surrounding the display region E in a frame shape. The first peripheral electrode 108 is disposed in a direction along the X-axis and a direction along the Y-axis. The first peripheral electrode 108 is disposed outside the display region E. The first peripheral electrode 108 is disposed inside the seal material 60. The first peripheral electrode 108 is disposed at a position not overlapping the seal material 60. The first peripheral electrode 108 is disposed at a position at least partially overlapping the partition portion 24 in plan view from the +Z direction. The first peripheral electrode 108 is formed of a transparent conductive film such as ITO or IZO. The first peripheral electrode 108 corresponds to an example of a first electrode.

The first peripheral electrode 108 is electrically coupled to any of the plurality of external coupling terminals 104. A DC potential having a positive polarity with respect to the common electrode potential applied to the common electrode 21 is applied to the first peripheral electrode 108. The DC potential applied to the first peripheral electrode 108 is a constant potential with reference to the common electrode potential. The DC potential applied to the first peripheral electrode 108 is, as an example, from +0.5 V to +3.0 V. The potential may be constantly applied to the first peripheral electrode 108 during operation of the liquid crystal device 100, or may be intermittently applied.

The second peripheral electrode 109 attracts the ionic impurities Im. The second peripheral electrode 109 is disposed at position surrounding the display region E in a frame shape. The second peripheral electrode 109 is disposed in the direction along the X-axis and the direction along the Y-axis. The second peripheral electrode 109 is disposed outside the display region E. The second peripheral electrode 109 is disposed at position surrounding the first peripheral electrode 108 in a frame shape. The second peripheral electrode 109 is disposed at a position surrounded by the seal material 60 disposed in a frame shape. The second peripheral electrode 109 is disposed at a position not overlapping the first peripheral electrode 108 and the seal material 60. The second peripheral electrode 109 is formed of a transparent conductive film such as ITO or IZO. The second peripheral electrode 109 corresponds to an example of a second electrode.

The second peripheral electrode 109 is electrically coupled to any of the plurality of external coupling terminals 104. A DC potential having a negative polarity with respect to the common electrode potential applied to the common electrode 21 is applied to the second peripheral electrode 109. The DC potential applied to the second peripheral electrode 109 is a constant potential with reference to the common electrode potential. The DC potential applied to the second peripheral electrode 109 is, as an example, from −3.0 V to −0.5 V. The potential may be constantly applied to the second peripheral electrode 109 during the operation of the liquid crystal device 100, or may be intermittently applied.

A width along the X-axis of the first peripheral electrode 108 extending along the Y-axis is shorter than a width along the X-axis of the second peripheral electrode 109 extending along the Y-axis. A width along the Y-axis of the first peripheral electrode 108 extending along the X-axis is shorter than a width along the Y-axis of the second peripheral electrode 109 extending along the X-axis. The width of the first peripheral electrode 108 is smaller than the width of the second peripheral electrode 109 over an entire circumference. The width of the first peripheral electrode 108 is, as an example, about 300 μm. The width of the second peripheral electrode 109 is, as an example, about 600 μm. The width of the first peripheral electrode 108 and the width of the second peripheral electrode 109 are set as appropriate.

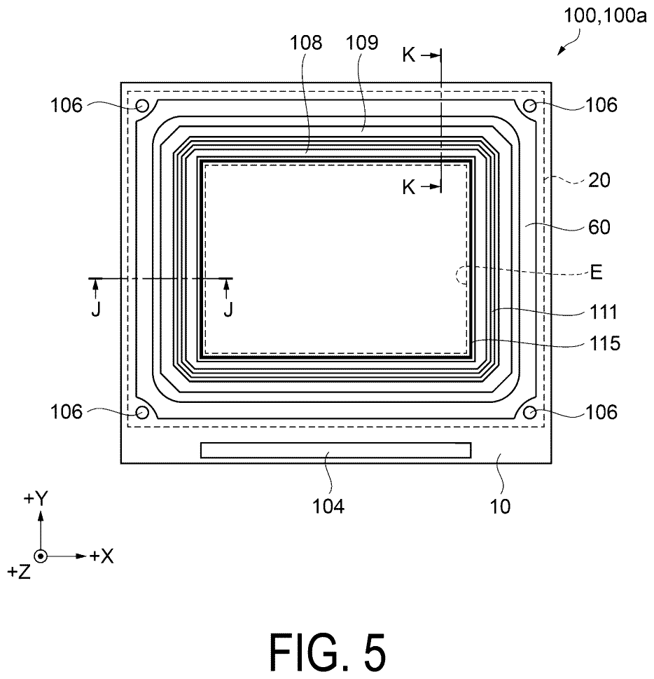

FIG. 5 illustrates an example of a schematic configuration of the liquid crystal device 100. FIG. 5 illustrates a schematic configuration of a first liquid crystal device 100a which is an example of the liquid crystal device 100. FIG. 5 illustrates the first liquid crystal device 100a in plan view from the +Z direction. The first liquid crystal device 100a includes a first concave-convex member 111 and a second concave-convex member 115 along the first peripheral electrode 108.

The first concave-convex member 111 of the first liquid crystal device 100a is disposed between the first peripheral electrode 108 and the second peripheral electrode 109 in plan view from the +Z direction. The first concave-convex member 111 is formed in a frame shape in plan view from the +Z direction. The first concave-convex member 111 is disposed along the first peripheral electrode 108 and the second peripheral electrode 109.

The second concave-convex member 115 of the first liquid crystal device 100a is disposed between the first peripheral electrode 108 and the display region E in plan view from the +Z direction. The second concave-convex member 115 is formed in a frame shape in plan view from the +Z direction. The second concave-convex member 115 is disposed along the first peripheral electrode 108 and an outer edge of the display region E.

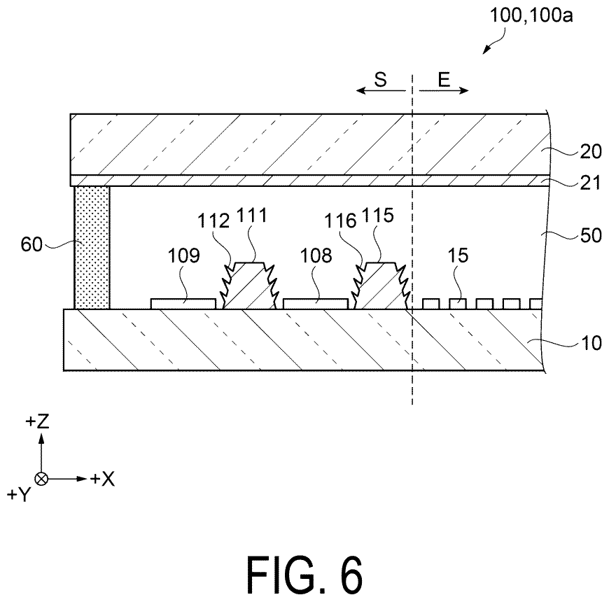

FIG. 6 illustrates an example of a schematic configuration of the liquid crystal device 100. FIG. 6 illustrates a schematic configuration of the first liquid crystal device 100a which is an example of the liquid crystal device 100. FIG. 6 illustrates an example of a schematic configuration of a peripheral region S. FIG. 6 illustrates a J-J cross-section illustrated in FIG. 5 in plan view from the −Y direction. FIG. 6 illustrates a part of the display region E and the peripheral region S. The peripheral region S denotes a region outside the display region E. In the display region E, a plurality of the pixel electrodes 15 are disposed. The seal material 60, the first peripheral electrode 108, the second peripheral electrode 109, the first concave-convex member 111, and the second concave-convex member 115 are disposed in the peripheral region S.

The first concave-convex member 111 illustrated in FIG. 6 is disposed in a direction along the Y-axis. The direction along the Y-axis corresponds to an example of a first direction. The first concave-convex member 111 prevents the ionic impurities Im from moving to the display region E. The first concave-convex member 111 corresponds to an example of a concave-convex member.

The first concave-convex member 111 may be made of silicon oxide (SiO₂). The first concave-convex member 111 is formed in the shape illustrated in FIG. 6 by etching silicon oxide. A method of molding the first concave-convex member 111 will be described later.

A first concave-convex member height, which is a height of the first concave-convex member 111 along the Z-axis with reference to the surface of the element substrate 10 in the +Z direction, is configured to be larger than a first peripheral electrode height and a second peripheral electrode height. The surface of the element substrate 10 in the +Z direction is a surface at which the first peripheral electrode 108 and the second peripheral electrode 109 are disposed, and corresponds to an example of a disposition surface. The first peripheral electrode height is a height of the first peripheral electrode 108 along the Z-axis with reference to the surface of the element substrate 10 in the +Z direction. The second peripheral electrode height is a height of the second peripheral electrode 109 along the Z-axis with reference to the surface of the element substrate 10 in the +Z direction. The first concave-convex member height corresponds to an example of a concave-convex member height. The first peripheral electrode height corresponds to an example of a first electrode height. The second peripheral electrode height corresponds to an example of a second electrode height. By configuring the first concave-convex member height to be larger than the first peripheral electrode height and the second peripheral electrode height, the movement of the ionic impurities Im to the display region E can be further suppressed.

A width of the first concave-convex member 111 is configured to be 10 to 100 μm. The first concave-convex member 111 may extend continuously along the X-axis and the Y-axis, or may be divided into predetermined lengths along the X-axis and the Y-axis. When the first concave-convex member 111 is divided, the first concave-convex member 111 is configured to have a length of 10 to 100 μm and a pitch of 1 to 10 μm, as an example.

A surface of the first concave-convex member 111 may be configured with a first concave-convex surface 112. The first concave-convex surface 112 is formed at the first concave-convex member 111 by, as an example, forming the first concave-convex member 111 by etching. The first concave-convex surface 112 illustrated in FIG. 6 is formed at a side surface of the first concave-convex member 111. The first concave-convex surface 112 is formed with a surface roughness of 10 to 50 nm, as an example. By configuring the first concave-convex surface 112, the first concave-convex member 111 can further prevent the movement of the ionic impurities Im. The first concave-convex surface 112 corresponds to an example of a concave-convex surface.

The second concave-convex member 115 illustrated in FIG. 6 is disposed in the direction along the Y-axis. The second concave-convex member 115 prevents the ionic impurities Im from moving to the display region E. The second concave-convex member 115 corresponds to an example of the concave-convex member.

The second concave-convex member 115 may be made of silicon oxide (SiO₂). The second concave-convex member 115 is formed in the shape illustrated in FIG. 6 by etching silicon oxide.

A second concave-convex member height, which is a height of the second concave-convex member 115 along the Z-axis, is configured to be larger than the first peripheral electrode height and the second peripheral electrode height. The second concave-convex member height corresponds to an example of the concave-convex member height. By configuring the second concave-convex member height to be larger than the first peripheral electrode height and the second peripheral electrode height, the movement of the ionic impurities Im to the display region E can be further suppressed.

A width of the second concave-convex member 115 is configured to be 10 to 100 μm. The second concave-convex member 115 may extend continuously along the X-axis and the Y-axis, or may be divided into predetermined lengths along the X-axis and the Y-axis. When the second concave-convex member 115 is divided, the second concave-convex member 115 is configured to have a length of 10 to 100 μm and a pitch of 1 to 10 μm, as an example.

The second concave-convex member 115 may be formed in the same shape as the first concave-convex member 111, or may be formed in a different shape. The second concave-convex member 115 may be formed in the same shape as the first concave-convex member 111. By making the first concave-convex member 111 and the second concave-convex member 115 have the same configuration, the first concave-convex member 111 and the second concave-convex member 115 are easily molded.

A surface of the second concave-convex member 115 may be configured with a second concave-convex surface 116. The second concave-convex surface 116 is formed at the second concave-convex member 115 by, as an example, forming the second concave-convex member 115 by etching. The second concave-convex surface 116 illustrated in FIG. 6 is formed at a side surface of the second concave-convex member 115. The second concave-convex surface 116 is formed with a surface roughness of 10 to 50 nm, as an example. By configuring the second concave-convex surface 116, the second concave-convex member 115 can further prevent the movement of the ionic impurities Im.

The liquid crystal device 100 illustrated in FIG. 6 includes the first concave-convex member 111 and the second concave-convex member 115, but is not limited thereto. The liquid crystal device 100 need not include the second concave-convex member 115. The liquid crystal device 100 may include the first concave-convex member 111 and the second concave-convex member 115.

FIG. 6 illustrates a configuration of the J-J cross-section illustrated in FIG. 5. The configuration of a K-K cross-section illustrated in FIG. 5 is the same as the configuration illustrated in FIG. 6. The K-K cross-section is not illustrated. In the K-K cross section, the first peripheral electrode 108, the second peripheral electrode 109, the first concave-convex member 111, and the second concave-convex member 115 extend in the direction along the X-axis. The configurations of the first peripheral electrode 108, the second peripheral electrode 109, the first concave-convex member 111, and the second concave-convex member 115 in the K-K cross section are the same as the configurations illustrated in FIG. 6.

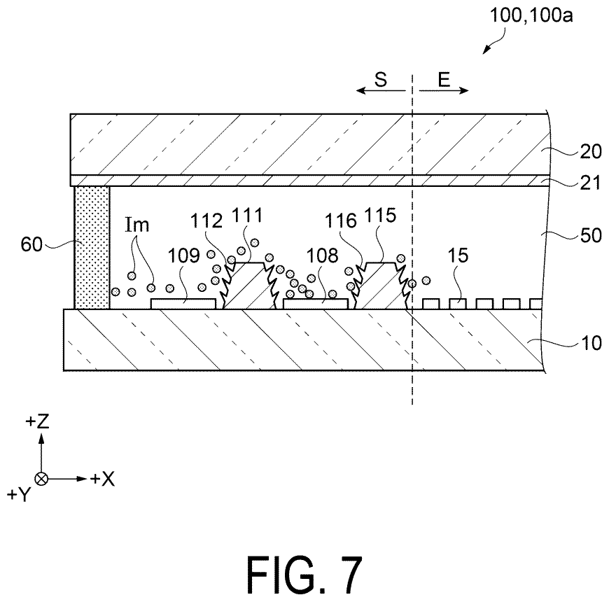

FIG. 7 illustrates an example of a schematic configuration of the liquid crystal device 100. FIG. 7 illustrates a schematic configuration of the first liquid crystal device 100a which is an example of the liquid crystal device 100. FIG. 7 illustrates an example of a schematic configuration of the peripheral region S. FIG. 7 illustrates the J-J cross-section illustrated in FIG. 5 in plan view from the −Y direction. FIG. 7 illustrates a part of the display region E and the peripheral region S. FIG. 7 schematically illustrates the ionic impurities Im. The ionic impurities Im are anionic, as an example.

When the first liquid crystal device 100a is in operation, a DC potential having a positive polarity is applied to the first peripheral electrode 108, and a DC potential having a negative polarity is applied to the second peripheral electrode 109. When the first liquid crystal device 100a is in operation, a lateral electric field is generated between the pixel electrode 15 and the first peripheral electrode 108, and the ionic impurities Im are attracted to the first peripheral electrode 108. When the operation of the liquid crystal device 100 is stopped, the application of the DC potentials to the first peripheral electrode 108 and the second peripheral electrode 109 is stopped. The ionic impurities Im are attracted to the second peripheral electrode 109 by ion concentration distribution diffusion. The ionic impurities Im move in the +X direction and the −X direction at a predetermined timing.

The first concave-convex member 111 and the second concave-convex member 115 prevent the ionic impurities Im from moving in the +X direction and the −X direction. By providing the first concave-convex member 111 and the second concave-convex member 115, the ionic impurities Im stay in the peripheral region S as illustrated in FIG. 7. The first concave-convex member 111 and the second concave-convex member 115 prevent the ionic impurities Im from moving to the display region E.

The first concave-convex surface 112 provided at the side surface of the first concave-convex member 111 and the second concave-convex surface 116 provided at the side surface of the second concave-convex member 115 prevent the ionic impurities Im from moving in the +X direction and the −X direction. By providing the first concave-convex surface 112 and the second concave-convex surface 116, the first concave-convex member 111 and the second concave-convex member 115 can further prevent the ionic impurities Im from moving to the display region E.

The first liquid crystal device 100a includes the liquid crystal layer 50 including the display region E, the first peripheral electrode 108 disposed in the peripheral region S, the second peripheral electrode 109 disposed in the peripheral region S and applied with a DC potential different from that of the first peripheral electrode 108, and the first concave-convex member 111 disposed between the first peripheral electrode 108 and the second peripheral electrode 109 in plan view from the +Z direction.

By providing the first concave-convex member 111, the ionic impurities Im are prevented from moving to the display region E. The deterioration in display quality due to the ionic impurities Im is further suppressed.

The first peripheral electrode 108, the second peripheral electrode 109, and the first concave-convex member 111 are each disposed along the direction along the Y-axis.

The first peripheral electrode 108, the second peripheral electrode 109, and the first concave-convex member 111 prevent the ionic impurities Im moving along the X-axis from moving to the display region E.

The first concave-convex member height of the first concave-convex member 111 is larger than the first peripheral electrode height of the first peripheral electrode 108 and the second peripheral electrode height of the second peripheral electrode 109.

By configuring the first concave-convex member height to be larger than the first peripheral electrode height and the second peripheral electrode height, the movement of the ionic impurities Im to the display region E can be further suppressed.

The side surface of the first concave-convex member 111 is configured with the first concave-convex surface 112.

The side surface of the first concave-convex member 111 is configured with the first concave-convex surface 112, and thus, it is possible to further prevent the ionic impurities Im from moving to the display region E.

The first concave-convex member 111 may be made of silicon oxide.

The first concave-convex member 111 is easily molded into a desired shape.

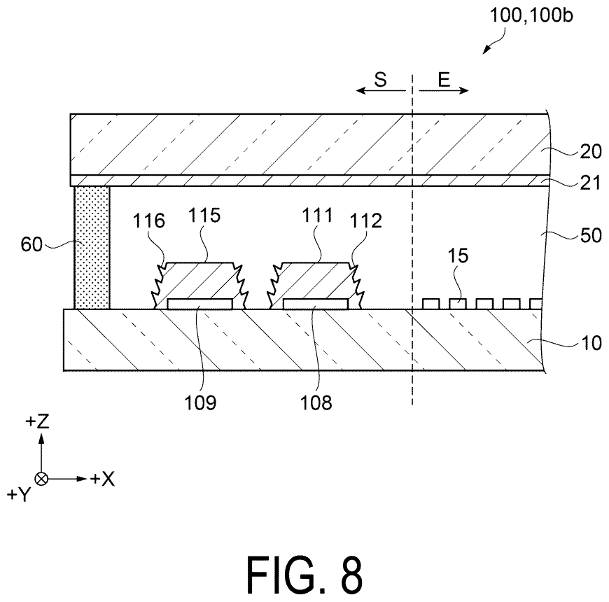

FIG. 8 illustrates an example of a schematic configuration of the liquid crystal device 100. FIG. 8 illustrates a schematic configuration of a second liquid crystal device 100b as an example of the liquid crystal device 100. FIG. 8 illustrates an example of a schematic configuration of the peripheral region S. FIG. 8 illustrates the J-J cross-section illustrated in FIG. 4 in plan view from the −Y direction. FIG. 8 illustrates a part of the display region E and the peripheral region S. In the display region E, a plurality of the pixel electrodes 15 are disposed. The seal material 60, the first peripheral electrode 108, the second peripheral electrode 109, the first concave-convex member 111, and the second concave-convex member 115 are disposed in the peripheral region S.

The first concave-convex member 111 of the second liquid crystal device 100b is formed above the first peripheral electrode 108. The first concave-convex member 111 covers the entire first peripheral electrode 108. The first concave-convex member 111 is disposed along the first peripheral electrode 108. The first concave-convex member 111 covers the first peripheral electrode 108, and thus, the ionic impurities Im attracted to the first peripheral electrode 108 are less likely to move, and it is possible to prevent the ionic impurities Im from moving to the display region E.

The second concave-convex member 115 of the second liquid crystal device 100b is formed above the second peripheral electrode 109. The second concave-convex member 115 covers the entire second peripheral electrode 109. The second concave-convex member 115 is disposed along the second peripheral electrode 109. The second concave-convex member 115 covers the second peripheral electrode 109, and thus, the ionic impurities Im attracted to the second peripheral electrode 109 are less likely to move, and it is possible to prevent the ionic impurities Im from moving to the display region E.

In the second liquid crystal device 100b illustrated in FIG. 8, the first concave-convex member 111 and the second concave-convex member 115 are formed in the same shape, but are not limited thereto. The first concave-convex member 111 and the second concave-convex member 115 may be formed in different shapes. The second concave-convex member 115 may be molded, as an example, in a shape so that the second concave-convex member height is lower than the first concave-convex member height.

The second liquid crystal device 100b illustrated in FIG. 8 includes the first concave-convex member 111 and the second concave-convex member 115, but is not limited thereto. The second liquid crystal device 100b may include either the first concave-convex member 111 or the second concave-convex member 115. In the second liquid crystal device 100b illustrated in FIG. 8, the first concave-convex member 111 covers the first peripheral electrode 108 and the second concave-convex member 115 covers the second peripheral electrode 109, but the present disclosure is not limited thereto. The second liquid crystal device 100b may have a configuration in which the second concave-convex member 115 covers the first peripheral electrode 108 and the first concave-convex member 111 covers the second peripheral electrode 109. By providing the first concave-convex member 111 or the second concave-convex member 115, the movement of the ionic impurities Im to the display region E is suppressed.

The second liquid crystal device 100b includes the liquid crystal layer 50 including the display region E, the first peripheral electrode 108 disposed in the peripheral region S, the second peripheral electrode 109 disposed in the peripheral region S and applied with a DC potential different from that of the first peripheral electrode 108, and the first concave-convex member 111 covering at least one of the first peripheral electrode 108 and the second peripheral electrode 109.

By providing the first concave-convex member 111, the ionic impurities Im are prevented from moving to the display region E. The deterioration in display quality due to the ionic impurities Im is suppressed.

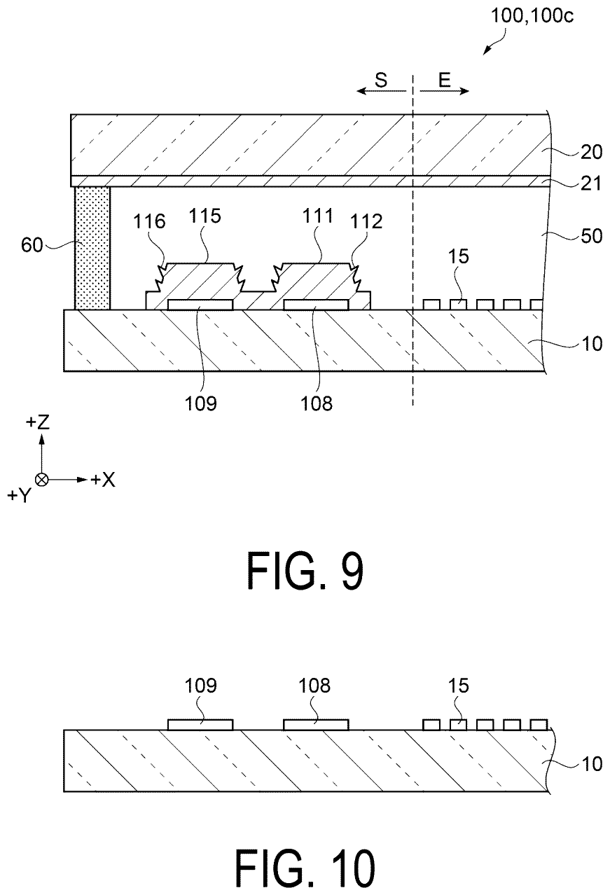

FIG. 9 illustrates an example of a schematic configuration of the liquid crystal device 100. FIG. 9 illustrates a schematic configuration of a third liquid crystal device 100c which is an example of the liquid crystal device 100. FIG. 9 illustrates an example of a schematic configuration of the peripheral region S. FIG. 9 illustrates the J-J cross-section illustrated in FIG. 4 in plan view from the −Y direction. FIG. 9 illustrates a part of the display region E and the peripheral region S. In the display region E, a plurality of the pixel electrodes 15 are disposed. The seal material 60, the first peripheral electrode 108, the second peripheral electrode 109, the first concave-convex member 111, and the second concave-convex member 115 are disposed in the peripheral region S.

The first concave-convex member 111 of the third liquid crystal device 100c is formed above the first peripheral electrode 108. The first concave-convex member 111 covers the entire first peripheral electrode 108. The first concave-convex member 111 is disposed along the first peripheral electrode 108. The first concave-convex member 111 covers the first peripheral electrode 108, and thus, the ionic impurities Im attracted to the first peripheral electrode 108 are less likely to move, and it is possible to prevent the ionic impurities Im from moving to the display region E.

The second concave-convex member 115 of the third liquid crystal device 100c is formed above the second peripheral electrode 109. The second concave-convex member 115 covers the entire second peripheral electrode 109. The second concave-convex member 115 is disposed along the second peripheral electrode 109. The second concave-convex member 115 covers the second peripheral electrode 109, and thus, the ionic impurities Im attracted to the second peripheral electrode 109 are less likely to move, and it is possible to prevent the ionic impurities Im from moving to the display region E.

The first concave-convex member 111 and the second concave-convex member 115 of the third liquid crystal device 100c are bonded to each other. The first concave-convex member 111 and the second concave-convex member 115 are bonded to each other between the first peripheral electrode 108 and the second peripheral electrode 109. The first concave-convex member 111 and the second concave-convex member 115 are bonded to each other, and thus the movement of the ionic impurities Im to the display region E is suppressed.

FIGS. 10 to 17 each illustrate a manufacturing process of the element substrate 10 of the liquid crystal device 100. FIGS. 10 to 17 each illustrate the manufacturing process of the element substrate 10 of the third liquid crystal device 100c, which is an example of the liquid crystal device 100. The first concave-convex member 111 and the second concave-convex member 115 are formed above the element substrate 10 by the manufacturing processes of FIGS. 10 to 17.

FIG. 10 illustrates the element substrate 10 after an ITO film forming process. The pixel electrode 15, the first peripheral electrode 108, and the second peripheral electrode 109 are formed by performing the ITO film forming process. The pixel electrode 15, the first peripheral electrode 108, and the second peripheral electrode 109 are formed by applying photo-etching to an ITO film. The pixel electrode 15, the first peripheral electrode 108, and the second peripheral electrode 109 are formed above the element substrate 10 at the same time.

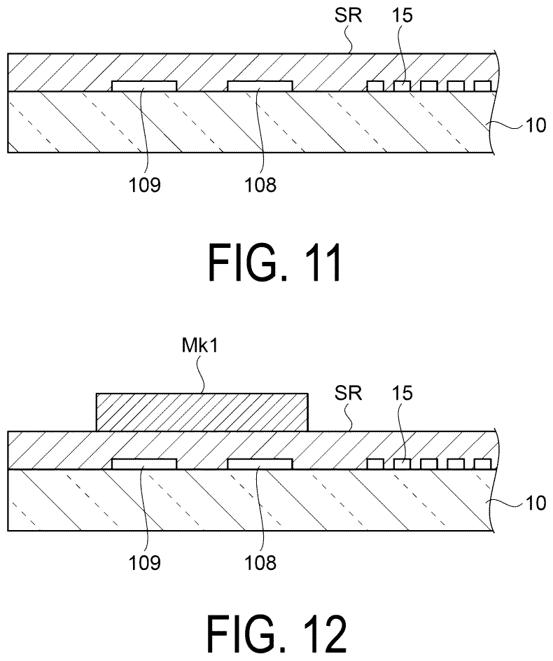

FIG. 11 illustrates the element substrate 10 after a silicon oxide film forming process. The silicon oxide film forming process is performed after the ITO film forming process. In the silicon oxide film forming process, a silicon oxide layer SR is formed above the element substrate 10. The silicon oxide layer SR is formed above the pixel electrode 15, the first peripheral electrode 108, and the second peripheral electrode 109.

FIG. 12 illustrates the element substrate 10 after a first mask forming process. The first mask forming process is performed after the silicon oxide film forming process. In the first mask forming process, a first mask Mk1 is formed above the silicon oxide layer SR. The first mask Mk1 is formed above the silicon oxide layer SR by applying a resist material above the silicon oxide layer SR, and then exposing and developing the resist material. The first mask Mk1 is formed above the first peripheral electrode 108 and above the second peripheral electrode 109. The first mask Mk1 is not formed above the pixel electrode 15.

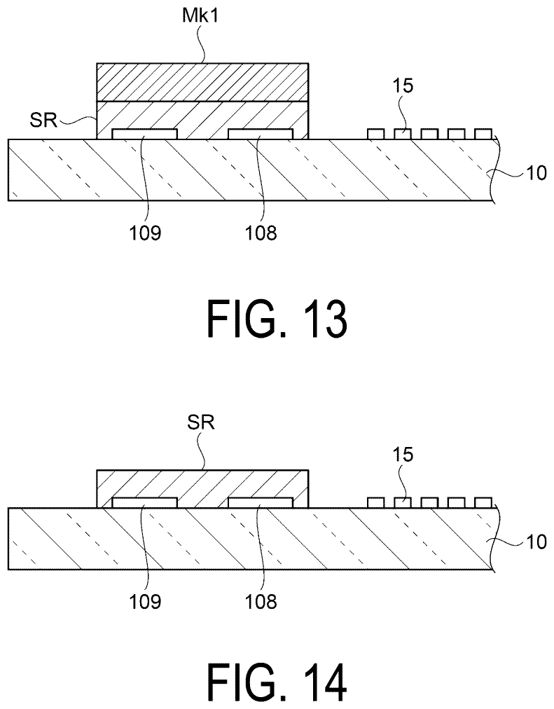

FIG. 13 illustrates the element substrate 10 after a first dry etching process. The first dry etching process is performed after the first mask forming process. In the first dry etching process, the silicon oxide film SR in a region where the first mask Mk1 is not formed is removed. Dry etching used in the first dry etching process is, as an example, reactive ion etching (RIE) using a fluoride gas such as trifluoromethane (CHF3) as a reactive gas. After the first dry etching process is performed, the silicon oxide layer SR above the first peripheral electrode 108 and above the second peripheral electrode 109 is maintained.

FIG. 14 illustrates the element substrate 10 after a first mask removal process. The first mask removal process is performed after the first dry etching process. In the first mask removal process, the first mask Mk1 formed above the silicon oxide layer SR is removed.

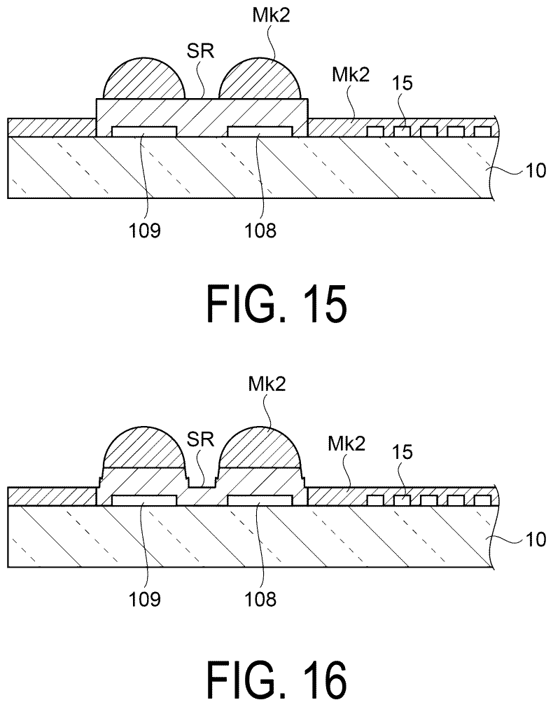

FIG. 15 illustrates the element substrate 10 after a second mask forming process. The second mask forming process is performed after the first mask removal process. In the second mask forming process, second masks Mk2 are formed above the silicon oxide layer SR and above the element substrate 10. The second masks Mk2 are formed above the silicon oxide layer SR and above the device substrate 10 by applying resist materials above the silicon oxide layer SR and above the element substrate 10, and then exposing and developing the resist materials. By heating and melting the resist materials, the second masks Mk2 above the silicon oxide layer SR are formed in a hemispherical shape by surface tension.

FIG. 16 illustrates the element substrate 10 after a second dry etching process. The second dry etching process is performed after the second mask forming process. Dry etching used in the second dry etching process is, as an example, RIE, similarly to the dry etching used in the first dry etching process. In the second dry etching process, the silicon oxide layer SR and the second masks Mk are etched. In the second dry etching process, the etching is terminated before a height of the second mask Mk2 above the pixel electrode 15 becomes a height of the pixel electrode 15. When the second dry etching process is performed, minute unevenness is formed at a side surface of the silicon oxide layer SR.

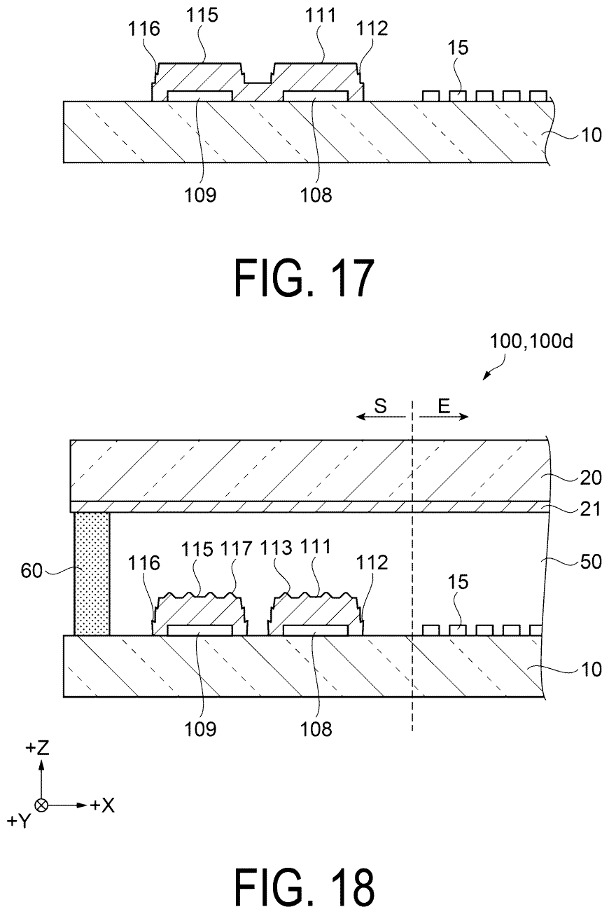

FIG. 17 illustrates the element substrate 10 after a second mask removal process. The second mask removal process is performed after the second dry etching process. By performing the second mask removal process, the element substrate 10 including the first concave-convex member 111 and the second concave-convex member 115 is formed. The element substrate 10 illustrated in FIG. 17 is the element substrate 10 used in the third liquid crystal device 100c.

The first concave-convex member 111 and the second concave-convex member 115 illustrated in FIG. 17 are bonded to each other between the first peripheral electrode 108 and the second peripheral electrode 109. The side surface of the first concave-convex member 111 is configured with the first concave-convex surface 112. The side surface of the second concave-convex member 115 is configured with the second concave-convex surface 116. The first concave-convex surface 112 and the second concave-convex surface 116 are formed by the second dry etching process.

An upper surface of the first concave-convex member 111 and an upper surface of the second concave-convex member 115 illustrated in FIG. 17 are configured with smooth surfaces. The upper surface of the first concave-convex member 111 and the upper surface of the second concave-convex member 115 are protected by the second mask Mk2, and thus are configured with the smooth surfaces.

FIGS. 10 to 17 illustrate the manufacturing processes of molding the first concave-convex member 111 and the second concave-convex member 115 of the third liquid crystal device 100c. The shape of the first concave-convex member 111 and the shape of the second concave-convex member 115 can be appropriately molded by adjusting formation conditions of the silicon oxide layer SR, formation conditions of the first mask Mk, and the like.

FIG. 18 illustrates an example of a schematic configuration of the liquid crystal device 100. FIG. 18 illustrates a schematic configuration of a fourth liquid crystal device 100d which is an example of the liquid crystal device 100. FIG. 18 illustrates an example of a schematic configuration of the peripheral region S. FIG. 18 illustrates the J-J cross-section illustrated in FIG. 4 in plan view from the −Y direction. FIG. 18 illustrates a part of the display region E and the peripheral region S. In the display region E, a plurality of the pixel electrodes 15 are disposed. The seal material 60, the first peripheral electrode 108, the second peripheral electrode 109, the first concave-convex member 111, and the second concave-convex member 115 are disposed in the peripheral region S.

The first concave-convex member 111 of the fourth liquid crystal device 100d is formed above the first peripheral electrode 108. The first concave-convex member 111 covers the entire first peripheral electrode 108. The first concave-convex member 111 is disposed along the first peripheral electrode 108. The first concave-convex member 111 covers the first peripheral electrode 108, and thus, the ionic impurities Im attracted to the first peripheral electrode 108 are less likely to move, and it is possible to prevent the ionic impurities Im from moving to the display region E.

The upper surface of the first concave-convex member 111 of the fourth liquid crystal device upper 100d is configured with a first concave-convex upper surface 113. The upper surface of the first concave-convex member 111 is a surface of the first concave-convex member 111 in the +Z direction. The upper surface of the first concave-convex member 111 is a surface facing the counter substrate 20. The first concave-convex upper surface 113 is a surface having fine unevenness similarly to the first concave-convex surface 112. The first concave-convex upper surface 113 is formed by dry etching processing for the silicon oxide layer SR or under film formation conditions for the silicon oxide layer SR. By providing the first concave-convex upper surface 113, the movement of the ionic impurities Im to the display region E can be further prevented.

The second concave-convex member 115 of the fourth liquid crystal device 100d is formed above the second peripheral electrode 109. The second concave-convex member 115 covers the entire second peripheral electrode 109. The second concave-convex member 115 is disposed along the second peripheral electrode 109. The second concave-convex member 115 covers the second peripheral electrode 109, and thus, the ionic impurities Im attracted to the second peripheral electrode 109 are less likely to move, and it is possible to prevent the ionic impurities Im from moving to the display region E.

The upper surface of the second concave-convex member 115 of the fourth liquid crystal device 100d is configured with a second concave-convex upper surface 117. The upper surface of the second concave-convex member 115 is a surface of the second concave-convex member 115 in the +Z direction. The upper surface of the second concave-convex member 115 is a surface facing the counter substrate 20. The second concave-convex upper surface 117 is a surface having fine unevenness similarly to the second concave-convex surface 116. The second concave-convex upper surface 117 is formed by the dry etching processing for the silicon oxide layer SR or under the film formation conditions for the silicon oxide layer SR. By providing the second concave-convex upper surface 117, the movement of the ionic impurities Im to the display region E can be further prevented.

The first concave-convex member 111 and the second concave-convex member 115 illustrated in FIG. 18 are separated from each other between the first peripheral electrode 108 and the second peripheral electrode 109, but the present disclosure is not limited thereto. The first concave-convex member 111 and the second concave-convex member 115 may be bonded to each other between the first peripheral electrode 108 and the second peripheral electrode 109.

In the fourth liquid crystal device 100d illustrated in FIG. 18, the upper surface of the first concave-convex member 111 is configured with the first concave-convex upper surface 113, and the upper surface of the second concave-convex member 115 is configured with the second concave-convex upper surface 117, but the present disclosure is not limited thereto. The upper surface of the first concave-convex member 111 need not be configured with the first concave-convex upper surface 113. Alternatively, the upper surface of the second concave-convex member 115 need not be configured with the second concave-convex upper surface 117. As far as at least one of the upper surface of the first concave-convex member 111 and the upper surface of the second concave-convex member 115 has the configuration illustrated in FIG. 18, it is possible to prevent the ionic impurities Im from moving to the display region E.

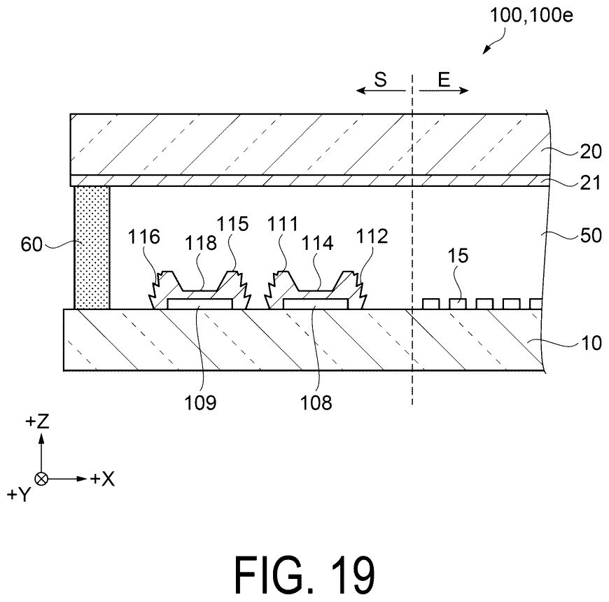

FIG. 19 illustrates an example of a schematic configuration of the liquid crystal device 100. FIG. 19 illustrates a schematic configuration of a fifth liquid crystal device 100e which is an example of the liquid crystal device 100. FIG. 19 illustrates an example of a schematic configuration of the peripheral region S. FIG. 19 illustrates the J-J cross-section illustrated in FIG. 4 in plan view from the −Y direction. FIG. 19 illustrates a part of the display region E and the peripheral region S. In the display region E, a plurality of the pixel electrodes 15 are disposed. The seal material 60, the first peripheral electrode 108, the second peripheral electrode 109, the first concave-convex member 111, and the second concave-convex member 115 are disposed in the peripheral region S.

The first concave-convex member 111 of the fifth liquid crystal device 100e is formed above the first peripheral electrode 108. The first concave-convex member 111 covers the entire first peripheral electrode 108. The first concave-convex member 111 is disposed along the first peripheral electrode 108. The first concave-convex member 111 covers the first peripheral electrode 108, and thus, the ionic impurities Im attracted to the first peripheral electrode 108 are less likely to move, and it is possible to prevent the ionic impurities Im from moving to the display region E.

The upper surface of the first concave-convex member 111 of the fifth liquid crystal device 100e includes a first recessed portion 114. The first recessed portion 114 corresponds to an example of a recessed portion. The first recessed portion 114 is formed by, as an example, applying dry etching processing to the upper surface of the first concave-convex member 111. By providing the first recessed portion 114, a movement distance of the ionic impurities Im to the display region E increases, and the movement of the ionic impurities Im to the display region E can be further prevented.

The second concave-convex member 115 of the fifth liquid crystal device 100e is formed above the second peripheral electrode 109. The second concave-convex member 115 covers the entire second peripheral electrode 109. The second concave-convex member 115 is disposed along the second peripheral electrode 109. The second concave-convex member 115 covers the second peripheral electrode 109, and thus, the ionic impurities Im attracted to the second peripheral electrode 109 are less likely to move, and it is possible to prevent the ionic impurities Im from moving to the display region E.

The upper surface of the second concave-convex member 115 of the fifth liquid crystal device 100e includes a second recessed portion 118. The second recessed portion 118 corresponds to an example of the recessed portion. The second recessed portion 118 is formed by, as an example, applying dry etching processing to the upper surface of the second concave-convex member 115. By providing the second recessed portion 118, the movement distance of the ionic impurities Im to the display region E increases, and the movement of the ionic impurities Im to the display region E can be further prevented.

The first concave-convex member 111 and the second concave-convex member 115 illustrated in FIG. 19 are separated from each other between the first peripheral electrode 108 and the second peripheral electrode 109, but the present disclosure is not limited thereto. The first concave-convex member 111 and the second concave-convex member 115 may be bonded to each other between the first peripheral electrode 108 and the second peripheral electrode 109.

In the fifth liquid crystal device 100e illustrated in FIG. 19, the first concave-convex member 111 includes the first recessed portion 114 and the second concave-convex member 115 includes the second recessed portion 118, but the present disclosure is not limited to this configuration. When the first concave-convex member 111 includes the first recessed portion 114, the second concave-convex member 115 need not include the second recessed portion 118. When the second concave-convex member 115 includes the second recessed portion 118, the first concave-convex member 111 need not include the first recessed portion 114.

The first concave-convex member 111 may include the first recessed portion 114 at the upper surface thereof.

By providing the first recessed portion 114, the movement distance of the ionic impurities Im to the display region E increases, and the movement of the ionic impurities Im to the display region E can be further prevented.

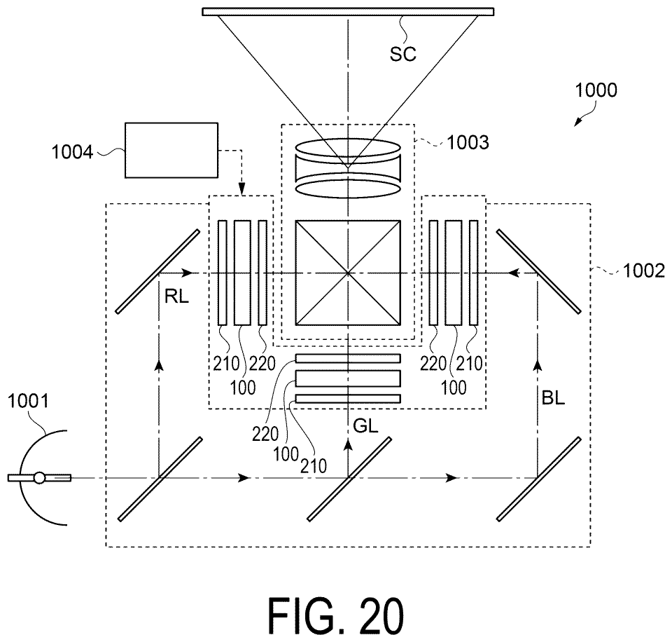

FIG. 20 illustrates a schematic configuration of a projection-type display device 1000. The projection-type display device 1000 corresponds to an example of an electronic apparatus. The projection-type display device 1000 is, as an example, a three-panel projector including three liquid crystal devices 100. The projection-type display device 1000 includes an illumination device 1001, an illumination optical system 1002, a projection optical system 1003, and a control unit 1004.

The illumination device 1001 is a light source that emits light to the illumination optical system 1002. The illumination device 1001 includes a lamp light source such as a halogen lamp, a xenon lamp, or an ultra-high pressure mercury lamp. The illumination device 1001 may include a solid-state light source such as a light emitting diode (LED) or a laser light source.

The illumination optical system 1002 separates light emitted from the illumination device 1001 into red light RL, green light GL, and blue light BL. The illumination optical system 1002 supplies the red light RL, the green light GL, and the blue light BL to the liquid crystal devices 100 provided corresponding to the respective colors of light.

The liquid crystal device 100 modulates light supplied from the illumination optical system 1002. Any one of the first liquid crystal device 100a, the second liquid crystal device 100b, the third liquid crystal device 100c, the fourth liquid crystal device 100d, and the fifth liquid crystal device 100e is used for the liquid crystal device 100. The three liquid crystal devices 100 each function as a light modulation device that modulates separated light in any of the red light RL, the green light GL, and the blue light BL in accordance with a display image. A first polarizing plate 210 is disposed on a light incident side of each liquid crystal device 100. A second polarizing plate 220 is disposed on a light emission side of each liquid crystal device 100. The first polarizing plate 210 and the second polarizing plate 220 disposed at the liquid crystal device 100 are provided in a crossed Nicol disposition in which respective transmission axes along which light is transmitted are orthogonal to each other. The liquid crystal device 100 emits light to the projection optical system 1003 via the second polarizing plate 220.

The projection optical system 1003 combines the red light RL, the green light GL, and the blue light BL modulated by the respective liquid crystal devices 100 with each other to form image light. The projection optical system 1003 projects the image light onto a screen SC.

The control unit 1004 is a controller that controls each unit of the projection-type display device 1000. As an example, the control unit 1004 is a processor including a central processing unit (CPU), as an example. The control unit 1004 includes one or a plurality of processors. The control unit 1004 may include a semiconductor memory such as a read only memory (ROM) or a random access memory (RAM). The semiconductor memory functions as a work area of the control unit 1004. The control unit 1004 controls each of the liquid crystal devices 100 to modulate the red light RL, the green light GL, and the blue light BL supplied from the illumination optical system 1002 according to a display image.

The projection-type display device 1000 is not limited to the three-panel projector. The projection-type display device 1000 may be a single-panel or two-panel projector, or a projector including four or more liquid crystal devices 100. A device that includes the liquid crystal device 100 may be a smartphone, a personal digital assistant (PDA), a camera, a television, a car navigation device, a personal computer, a display, an electronic paper, a calculator, a videophone, a point of sale (POS), a printer, a scanner, a copier, a video player, or a device equipped with a touch panel, or the like. A device including the liquid crystal device 100 corresponds to an example of an electronic apparatus.

The projection-type display device 1000 may include any one of the first liquid crystal device 100a, the second liquid crystal device 100b, the third liquid crystal device 100c, the fourth liquid crystal device 100d, and the fifth liquid crystal device 100e.

It is possible to provide the projection-type display device 1000 in which deterioration in display quality due to the ionic impurities Im is suppressed and display quality is maintained.

What is claimed is:

1. An electro-optical device, comprising:
an electro-optical layer;
a first electrode disposed outside a pixel region;
a second electrode disposed outside the pixel region and applied with a potential different from that of the first electrode; and
a concave-convex member disposed between the first electrode and the second electrode in plan view.

2. The electro-optical device according to claim 1, wherein
the first electrode, the second electrode, and the concave-convex member are each disposed along a first direction.

3. The electro-optical device according to claim 1, wherein
a concave-convex member height of the concave-convex member with reference to a disposition surface at which the first electrode and the second electrode are disposed is larger than a first electrode height of the first electrode with reference to the disposition surface and a second electrode height of the second electrode with reference to the disposition surface.

4. The electro-optical device according to claim 1, wherein
a side surface of the concave-convex member includes a concave-convex surface.

5. The electro-optical device according to claim 1, wherein
the concave-convex member includes a recessed portion at an upper surface.

6. The electro-optical device according to claim 1, wherein
the concave-convex member includes silicon oxide.

7. An electro-optical device, comprising:
an electro-optical layer;
a first electrode disposed outside a pixel region;
a second electrode disposed outside the pixel region and applied with a potential different from that of the first electrode; and
a concave-convex member covering at least one of the first electrode and the second electrode.

8. An electronic apparatus comprising the electro-optical device according to claim 1.
